(19) United States
(12) Patent Application Publication
(10) Pub. No.: US 2025/0089695 A1
(43) Pub. Date: Mar. 20, 2025

(54) TRAY TRAP FOR PLANT PESTS

(71) Applicant: BAYER AKTIENGESELLSCHAFT, Leverkusen (DE)

(72) Inventor: Matthias TEMPEL, Köln (DE)

(21) Appl. No.: 18/562,287

(22) PCT Filed: May 12, 2022
(86) PCT No.: PCT/EP2022/062899

§ 371 Date: Nov. 17, 2023

(30) Foreign Application Priority Data
May 21, 2021 (EP) 21175311.6

(51) Int. Cl. A01M 1/02; A01M 1/04

(52) U.S. Cl. CPC A01M 1/026; A01M 1/04

(57) ABSTRACT

The present invention relates to a device and a method for immobilizing plant pests for identification purposes.

The present invention relates to a device and a method for immobilizing plant pests for identification purposes.

About two thirds of the species currently known are arthropods (phylum of Arthropoda), 85% of which are insects. A considerable proportion of arthropods is phytophagous: these animals feed on plants and can lead to impairment of plant growth, cause suction and biting damage, and transmit viral diseases. This causes, for example, considerable losses of yield and quality in the growing of crop plants.

In modern agriculture, an important role is played by the detection and recognition of pests within areas utilized agriculturally. WO2018054767, WO2020058170 and WO2020058175 disclose trap dishes which can be filled with water and additives to immobilize pests.

If multiple pests enter the trap dishes, these pests can accumulate in one or more groups and obscure one another. The identification of individual pests in such accumulations is often difficult to impossible; the pests must first of all be separated from one another and isolated in order to be able to identify them.

As described in WO2020058170 and WO2020058175, trap dishes can be equipped with a camera. The camera is mounted at a defined distance above the bottom of the dish such that an image of the bottom of the trap dish is projected onto a sensor of the camera. The camera allows the content of the trap dish to be checked remotely. The images taken by such a camera can be analyzed (in automated fashion) in order to detect, count and/or identify pests. However, such (automated) analysis of all the individual pests remotely is not possible if the pests have accumulated in one or more groups.

Proceeding from the described prior art, the technical object is therefore to prevent accumulation of pests in a trap dish.

This object is achieved by the subjects of the independent claims. Preferred embodiments of the present invention are found in the dependent claims, in the present description and in the drawings.

A first subject of the present invention is a device for immobilizing pests, comprising a dish for receiving a liquid, wherein the dish comprises a bottom and walls which provide a volume for receiving the liquid, characterized in that the bottom has a plurality of depressions.

A further subject of the present invention is a method comprising the following steps:
providing a device, wherein the device comprises a dish for receiving a liquid, wherein the dish comprises a bottom and walls, wherein the bottom and the walls provide a volume for receiving the liquid, wherein the bottom has a plurality of depressions,
filling the dish with the liquid,
identifying a pest located in a depression of the dish or identifying and/or counting a plurality of pests in a plurality of depressions of the dish.

A further subject of the present invention is the use of a device for immobilizing and/or identifying pests, preferably in an area where crop plants are cultivated, wherein the device comprises:
a dish for receiving a liquid, wherein the dish comprises a bottom and walls which provide a volume for receiving the liquid, characterized in that the bottom has a plurality of depressions.

The invention is described in more detail below without distinguishing between the subjects of the invention (device, method, use). The explanations that follow shall instead apply analogously to all subjects of the invention, regardless of the context (device, method, use) in which they are provided.

Where steps are stated in an order in the present description or in the claims, this does not necessarily mean that the invention is limited to the order stated. Instead, it is conceivable that the steps are also executed in a different order or else in parallel with one another, the exception being when one step builds on another step, thereby making it imperative that the step building on the previous step be executed next (which will however become clear in the individual case). The orders stated are thus preferred embodiments of the invention.

The device according to the invention, its construction and its mode of operation can be described particularly clearly on the basis of a device which contains at least one liquid and is set up or suspended or otherwise fixed in one place. However, this should not mean that the invention is limited to a liquid-filled and fixed device. For example, a device according to the invention is usually offered as a commercial product without a liquid already present therein and the device is usually not already fixed in place as commercial product. However, a corresponding commercial product is to be protected by the present intellectual property right. Thus, when reference is made to a liquid in the description and/or definition of the device according to the invention, or the device is described in a defined position, the scope of protection is of course also intended to cover a device without any liquid and in any position.

The invention serves to immobilize pests. A “pest” is understood to mean a mobile organism which can appear in the growing of plants and damage plants, or adversely affect the harvest of the plants. The pest is preferably an insect (in the various stages from larva (caterpillar, pseudo-caterpillar) up to the adult stage) or an arachnid.

Pests have to be “mobile” in the sense that they can autonomously enter the dish of the device.

The term “immobilize” means that pests that enter the device cannot leave it autonomously again, at least for a certain period of time. Within the defined period of time, one or more image recordings of the pests located in the device can be produced with the aid of a camera in order to be able to identify and/or count the pests depicted in the image recordings.

The device has a dish within which pests are immobilized. This is preferably achieved by means of a liquid in the dish. Pests that enter the liquid are usually no longer able to leave it autonomously or are at least restrained by the liquid for a certain period of time. It is conceivable that pests drown in the liquid and/or are restrained by the liquid.

The liquid is usually water or the liquid usually comprises water, preferably as main constituent. One or more additives may be added to the liquid. Such an additive may, for example, be a surfactant for lowering surface tension. Such an additive may, for example, be a thickener for increasing the viscosity of the liquid. Such an additive may also be an attractant for attracting (specific) pests. Such an additive may also be a means for preventing algae formation (for example a herbicide). Such an additive may also be a colorant. Further additives are conceivable.

The dish may have a specific color and/or a specific pattern in order to attract pests. For example, many oilseed rape pests are attracted by a yellow color; to attract oilseed rape pests, the dish can as a whole or in part have a yellow color. Some moths are, for example, attracted by a striped pattern; the dish may thus completely or partially have a striped pattern. Some pests are attracted by electromagnetic radiation in a specific wavelength range; the dish may thus comprise one or more sources of electromagnetic radiation in a specific wavelength range.

The dish has a bottom and walls. The bottom delimits the dish in one spatial direction (“downward”). In the opposite spatial direction (“upward”), the dish is usually open so that pests can enter the dish. To the sides, the dish is usually delimited by walls.

When the dish is filled with a liquid, the liquid remains in the dish because the bottom and the walls prevent it from flowing out.

If liquid is introduced into the interior of the dish, the volume of liquid in the interior of the dish defines a congregation region in which pests can congregate. The pests can float on the surface of the liquid, float in the volume of liquid and/or sink to the bottom of the dish in the volume of liquid. The volume of the congregation region is delimited on one side by the bottom of the dish, on other sides by the walls of the dish and on the open side of the dish by the surface of the liquid.

A dish in the sense of the present invention may, for example, have the shape of a cylinder with one of the bases of the cylinder missing (a cylinder open to one side). A dish in the sense of the present invention may, for example, have the shape of a frustum of a cone with a base of the frustum of a cone (preferably the one with the larger surface area) missing. A dish in the sense of the present invention may, for example, have the shape of a cuboid with a base of the cuboid missing. A dish in the sense of the present invention may, for example, have the shape of a frustum of a pyramid with a base of the frustum of a pyramid (preferably the one with the larger surface area) missing. Further shapes, in particular mixed shapes of the shapes mentioned, are conceivable.

It is conceivable that the dish is provided “upward” with a cover, wherein the cover has one or more openings through which (specific) pests can enter the dish. It is conceivable that the size of such an opening or a plurality of openings is matched to the size of specific pests, for example in order to selectively allow pests to enter the dish that can pass through the opening(s) owing to their (smaller) size, while larger pests and/or larger objects (for example plant parts or other contamination) that cannot pass through the opening(s) owing to their size cannot enter the dish. It is conceivable, for example, that such a cover comprises a lattice, wherein the lattice spacings have a size which allows specific pests to pass through.

The bottom may have a round, oval, elliptical, polygonal (triangular, tetragonal, pentagonal, hexagonal or generally n-gonal, with n being an integer greater than or equal to three) or other shape (in plan view). Preferably, the bottom has a round or rectangular (in particular square) shape (in plan view). A rectangular shape has the advantage that the dish (or the bottom of the dish and/or the surface of a liquid in the dish) can be imaged over its entire surface area on a camera sensor, thereby making optimum use of the camera sensor. Particularly preferred is therefore a dish with an aspect ratio that corresponds to the aspect ratio of the camera sensor (e.g. 4:3, 3:2, 16:9 or another common format). Preferably, the corners are rounded. An oval, elliptical or round dish or a dish with rounded corners has the advantage that it is easier to clean than a dish with corners.

Preferably, the bottom of the dish has an oval, round, elliptical or other shape without corners in plan view. Such a shape makes it easier to clean the dish.

The bottom may be flat or curved if the depressions are imagined as not being present. Preferably, the bottom (if the depressions are imagined as not being present) has a flat form. A flat bottom has the advantage that all regions of the bottom can be sharply imaged on a camera.

The walls preferably extend conically or cylindrically at an angle to the bottom surface in the range of 60° to 120°, preferably in the range of 80° to 120°, even more preferably in the range of 90° to 110° from the bottom, so that the bottom and the walls form a space which is open to one side (to the “top”) but is otherwise delimited with respect to the environment by the bottom and the walls. This space serves to hold the liquid. In the present description, this space is also referred to as the interior of the dish.

In plan view, the bottom preferably spans a surface area of 10 cm₂ to 2000 cm₂, even more preferably of 50 cm₂ to 1000 cm₂.

The bottom has a multiplicity of depressions. Preferably, the depressions extend over the majority of the bottom. In other words: there are preferably more regions of the bottom that have depressions than there are regions of the bottom that do not have depressions. In other words: the bottom preferably comprises one or more first regions which comprise no depressions, and one or more second regions which comprise a plurality of depressions, wherein the one or more first regions occupy a first surface area and the one or more second regions occupy a second surface area, wherein the first surface area is smaller than the second surface area.

Preferably, the depressions extend over the entire bottom, it being optional for only one region along the walls to be free of depressions.

Preferably, the depressions are arranged such that they form a regular pattern, for example a triangular pattern, a square grid, a hexagonal grid or another pattern. Such a pattern may be helpful for setting the focus of the camera, for correcting lens errors (and/or other imaging errors) and/or for determining the size of pests. Preferably, the depressions are arranged such that in plan view a tiling can be identified. A tiling refers to the base being covered, without gaps and without overlap, by sub-areas of the same shape. The tiles may be Platonic or non-Platonic. In a preferred embodiment, the tiles are Platonic. Examples of tilings can be found in the following publications, the content of which is fully incorporated by reference in the present description:
http://www.mathematikinformation.info/pdf/MI39Heinrich.pdf
http://www.math.uni-magdeburg.de/reports/2002/parkett.pdf
http://www.willimann.org/A07020-Parkettierungen-Theorie.pdf
http://www.udo-rehle.de/pdf/iv-11c.pdf

In a preferred embodiment, the depressions have a round cross section and are arranged in the shape of a hexagonal grid. Such a structure is also referred to as honeycomb structure.

The depressions have a round, elliptical, polygonal (for example triangular, tetragonal, pentagonal, hexagonal, heptagonal, octagonal, or generally n-gonal, with n being an integer larger than 2) or other cross section. Depressions with different cross sections (shapes) are also conceivable.

The term “cross section” means, in the present description, preferably a section in the plane of the bottom (without depressions), unless stated otherwise.

The depressions may have the shape of a spherical segment (also referred to as spherical portion), a frustum of a cone, a frustum of a cylinder, a frustum of a pyramid, a cube, a cuboid or another shape. Preferably, they have the shape of a spherical segment, wherein the volume of the spherical segment is preferably smaller than half the volume of the sphere from which the spherical segment originates. Depressions which have such a trough or dome shape can be cleaned more easily than depressions with corners and/or edges.

In a preferred embodiment, each depression of the plurality of depressions provides a volume which is larger than the volume occupied by a specific (defined) pest but is smaller than the volume of two specific (defined) pests. In other words, the depression is preferably dimensioned such that one specific (defined) pest can enter it, but not two. Depending on the specific pest that is to enter the trap dish, those skilled in the art can dimension the depressions accordingly.

It is conceivable that the specific pest completely enters the depression or that the specific pest enters the depression with part (for example the majority) of its body, while part of the body protrudes beyond the (otherwise preferably flat) bottom surface.

The specific (defined) pest may for example be a pest which appears at the location where the device is in use or is intended to be used. It is, for example, conceivable that the device according to the invention is to be used in a field for specific crop plants or is used there in order to check for and/or monitor the presence of a specific pest for the specific crop plant.

An example of a specific crop plant is oilseed rape; an example of a specific pest is the oilseed rape stem weevil. Other examples of specific pests are: codling moth, aphid, thrips, summer fruit tortrix, Colorado potato beetle, cherry fruit fly, cockchafer, European corn borer, plum fruit moth, rhododendron leafhopper, turnip moth, scale insect, gypsy moth, spider mite, European grapevine moth, walnut husk fly, glasshouse whitefly, cabbage stem weevil, rape pollen beetle, cabbage shoot weevil, brassica pod midge or cabbage stem flea beetle, or a forestry pest, for example aphid, steelblue jewel beetle, bark beetle, oak splendour beetle, oak processionary moth, green oak tortrix, spruce webworm, common furniture beetle, great brown bark eater, common pine sawfly, pine beauty, pine looper, lesser spruce sawfly, pine moth, horse chestnut leaf miner, gypsy moth, brown powderpost beetle.

The depressions may have an extent of 1 mm to 2 mm in cross section.

Preferably, the depressions have an extent in cross section of 2 mm to 8 mm, even more preferably 3 mm to 6 mm. Preferably, the minimum extent (least extent) in cross section is at least 2 mm and the maximum extent (greatest extent) in cross section is at most 8 mm.

A depression with a shape which is square in plan view may, for example, have a side length of the square of 2 to 8 mm.

A depression with a shape which is round in plan view may, for example, have a circle diameter of 2 to 8 mm.

A depression with a shape which is rectangular in plan view may, for example, have side lengths of 2 to 8 mm in each case.

Preferably, the depressions have a depth of 1 mm to 5 mm, even more preferably 1 mm to 3 mm. Preferably, the depressions have a minimum depth (least depth) of at least 1 mm and a maximum depth (greatest depth) of 1 cm.

In a preferred embodiment, the depressions are arranged and dimensioned such that a camera mounted above the depressions can detect pests located in the depressions without significant shadowing or concealment by the depressions (in particular in the edge region close to the walls).

In a preferred embodiment, the size of the depressions can be variable. It is, for example, conceivable to provide inlays (inserts) which are introduced into the dish and ensure a plurality of depressions. It is, for example, conceivable to use lattice inserts with square cutouts which have different lattice spacings, for example a lattice with a lattice spacing of 3 mm, a further lattice with a spacing of 4 mm and a further lattice with a lattice spacing of 6 mm. Other lattice spacings are also conceivable. The lattices may also have round, elliptical, oval, n-gonal cutouts, with n being an integer greater than 2. Other shapes are also conceivable. The lattices may be closed on one side or open on both sides.

The depth of the plurality of depressions can also be variable by virtue of inlays (inserts). It is, for example, conceivable that there is a lattice insert which has a height of 1 mm, a further lattice insert which has a height of 1.5 mm, a further lattice insert which has a height of 2 mm, a further lattice insert which has a height of 3 mm, a further lattice insert which has a height of 4 mm, and a further lattice insert which has a height of 5 mm. Further heights are conceivable. Multiple lattice inserts can be stacked one on another in order to increase the height.

The inlays/inserts are of course not restricted to lattices. It is thus conceivable that a honeycomb structure insert with round depressions or cutouts in a hexagonal lattice arrangement is provided. A square arrangement of round depressions or cutouts (or depressions/cutouts of other shapes) is conceivable.

The inlays/inserts may be closed on one side (to the “bottom”) and open on one side (to the “top”) or open on both sides (to the “bottom” and to the “top”).

Apart from the increased variability in the isolation of pests, such inlays/inserts have the advantage that they can be cleaned more easily after removal from the dish than depressions which are permanently made in the bottom.

If liquid is introduced into the interior of the dish, the volume of liquid in the interior of the dish defines a congregation region in which pests can congregate. The depressions ensure that the pests settle in the depressions, with usually not more than one pest settling in a depression. Accumulation is reduced or even avoided.

Preferably, an amount of liquid is introduced into the dish which has the effect that the shortest distance between the surface of the liquid and part of the bottom that does not have any depressions is less than the depth of the depressions.

It is conceivable that the liquid in the device according to the invention is set in motion at defined points in time. Preferably, the device thus has means which set the liquid in the dish in motion at defined points in time. Such motion requires the distribution of pests in the liquid in the dish among individual depressions and their isolation, with the result that each depression does not comprise more than one pest. Such motion can for example be generated by a float on the surface of the liquid, the float, for example using a motor or a reciprocating piston, performing one or more movements on the surface of the liquid that lead to the generation of one or more waves. It is also conceivable that the walls or the bottom are jolted by means of a mechanical pulse generator or that the dish performs a horizontal movement or a tilting movement or the like.

For the use according to the invention, the device according to the invention is usually set up, suspended or otherwise fixed in a place. In so doing, the device is oriented such that the preferably flat bottom of the dish (when the depressions are imagined as not being present) extends preferably horizontally, i.e. parallel to the flat ground. Expressed differently: the surface normal (the perpendicular to the flat bottom surface of the dish) points in the direction of the center of the earth.

In a preferred embodiment, the device according to the invention comprises at least one camera and/or at least one mount for at least one camera.

Such a camera can be used to generate digital images. Such a camera comprises an image sensor (camera sensor) and optical elements. The image sensor is a device for recording two-dimensional images from light by electrical means. It typically comprises semiconductor-based image sensors, for example CCD (CCD=charge-coupled device) or CMOS sensors (CMOS=complementary metal-oxide-semiconductor). The optical elements (lenses, stops and the like) serve for maximum sharpness of imaging of the object of which a digital image is to be generated on the image sensor.

The at least one mount and/or the at least one camera is/are positioned such that the entire congregation region or at least part of the congregation region is imaged on the at least one image sensor. It is conceivable to use multiple cameras that image different regions of the congregation region on the respective image sensor. When using multiple cameras in this way, it is advantageous if the imaged regions at least partially overlap in order to be able to generate an overall image more easily from the individual image recordings at a later point in time.

At least one camera can preferably be reversibly fixed to the at least one mount. The at least one mount is preferably at a defined and constant distance from the congregation region, and hence ensures a defined and constant distance between the at least one image sensor and the congregation region.

It is conceivable that the device according to the invention is equipped with at least one source of electromagnetic radiation, preferably in the visible, infrared and/or ultraviolet range of the spectrum. With such a source of electromagnetic radiation, the congregation region can be illuminated so that digital image recordings of constant quality can be produced regardless of sunlight (i.e. also at night, for instance).

The digital images of the collecting region produced by the at least one camera can be analyzed by an expert or by a self-learning system to decide whether there is a pest in the congregation region and to count and/or to identify a pest present in the congregation region. Details of this can be found, for example, in the following publications: WO2020058170, WO2020058175,WO2018054767, KR1020100127473, WO0217119, O. Lopez et al.: Monitoring Pest Insect Traps by Means of Low-Power Image Sensor Technologies; Sensors 2012, Vol. 12 No. 12 pages 15801-15819.

In a preferred embodiment, the device according to the invention has a power supply, for example, in order to supply electrical power to a camera which is present and/or to means which is present for generating waves in the liquid in the dish to isolate the pests and/or to a control and management unit which is present. The power supply may be, for example, an electrochemical cell (battery), a rechargeable accumulator, a solar panel, a fuel cell, a wind turbine with a generator and/or another source of electrical power or a combination of the units mentioned.

Preferably, the device according to the invention has means by which the device can be positioned on a ground surface or in a ground surface. The device can preferably be secured in the ground surface in order to prevent it from falling over, for example in a storm. There are preferably means by which the distance between ground surface and congregation region can be varied. One example of such height adjustment means is a telescopic rod that can be secured in the ground surface by one end, and the congregation region can be mounted at the other end thereof. Another example of a height adjustment means is a lifting platform. Such a variable height adjustment means enables positioning of the congregation region above plants, such that flying insects can recognize the congregation region when flying over the plants. The variable height adjustment means allows the height of the congregation region (distance from the ground surface) to be matched to the growing plants in order to prevent the surrounding plants from concealing the congregation region. In a preferred embodiment, the height adjustment means is automatic; however, a manual height adjustment means is also possible. The height is preferably automatically matched such that the congregation region is always above or at the height of the surrounding plants. This can be accomplished by distance sensors and/or brightness sensors.

However, it is also conceivable that the device according to the invention has means by which it can be attached to a plant or another object, for example by means of a hook or a loop or a strap for attachment to a branch or twig or trunk.

In a preferred embodiment, the device according to the invention comprises a transmission unit with which camera images can be transmitted to a separate computer system. This transmission may, for example, take place via a network such as the mobile telephone network.

The device according to the invention may have further features, in particular features described in the publication WO2020058170 and/or the publication WO2020058175. The publications mentioned are hereby incorporated in their entirety in the present description by reference.

The most preferred embodiments are as follows:
1. A device for immobilizing pests, comprising a dish for receiving a liquid, wherein the dish comprises a bottom and walls which provide a volume for receiving the liquid, characterized in that the bottom has a plurality of depressions.
2. The device according to embodiment 1, wherein the majority of the bottom has depressions.
3. The device according to either of embodiments 1 and 2, wherein the depressions extend over the entire bottom, wherein it is optional for regions of the bottom that adjoin the walls to be free of depressions.
4. The device according to one of embodiments 1 to 3, wherein the depressions are arranged in a regular pattern.
5. The device according to one of embodiments 1 to 4, wherein the depressions form a Platonic tiling.
6. The device according to one of embodiments 1 to 5, wherein the depressions form the shape of a honeycomb structure.
7. The device according to one of embodiments 1 to 6, wherein each depression has a volume which completely or partially accommodates a specific pest, but does not accommodate two specific pests.
8. The device according to one of embodiments 1 to 7, wherein each depression has an extent of at least 2 mm and at most 8 mm in the plane of the bottom.
9. The device according to one of embodiments 1 to 8, wherein each depression has a depth of 1 mm to 5 mm.
10. The device according to one of embodiments 1 to 9, wherein the bottom with the depressions is formed by an insert which can be reversibly removed from the dish.
11. The device according to one of embodiments 1 to 10, also comprising means which discharge one or more pulses onto the walls and/or the bottom at defined points in time.
12. The device according to one of embodiments 1 to 10, also comprising a camera having an image sensor, wherein the image sensor has a rectangular shape with an aspect ratio, wherein the dish has a rectangular shape in plan view, wherein the corners are preferably rounded, wherein the rectangular shape of the dish has an aspect ratio corresponding to the aspect ratio of the image sensor of the camera.
13. A method comprising the following steps:
providing a device according to one of embodiments 1 to 12,
filling the dish with the liquid,
identifying a pest located in a depression of the dish or identifying and/or counting a plurality of pests in a plurality of depressions of the dish.
14. The method according to embodiment 13, wherein the dish is filled with an amount of liquid which has the effect that the shortest distance between the surface of the liquid and part of the bottom that does not have any depressions is less than the depth of the depressions.
15. The use of a device according to one of embodiments 1 to 12 for immobilizing and/or identifying pests, preferably in an area where crop plants are cultivated.

The invention is explained in more detail below with reference to drawings, without wishing to restrict the invention to the features and combinations of features that are shown in the drawings.

### IN THE FIGURES

FIG. 1 shows, by way of example and schematically, one embodiment of the device according to the invention (a) in plan view, (b) in cross section from the side and (c) in an enlarged illustration.

FIG. 2 shows, by way of example and schematically, one embodiment of a bottom of the device according to the invention (a) in plan view and (b) in cross section from one side.

FIG. 3 shows, by way of example and schematically, one embodiment of a bottom of the device according to the invention (a) in plan view and (b) in cross section from one side.

FIG. 4 shows, by way of example and schematically, one embodiment of an insert for a device according to the invention (a) in plan view and (b) in cross section from one side.

FIG. 5 shows, by way of example and schematically, one embodiment of the device according to the invention (a) in plan view, (b) in cross section from the side and (c) in an enlarged illustration.

FIG. 6 shows, by way of example and schematically, one embodiment of the device according to the invention in cross section from one side.

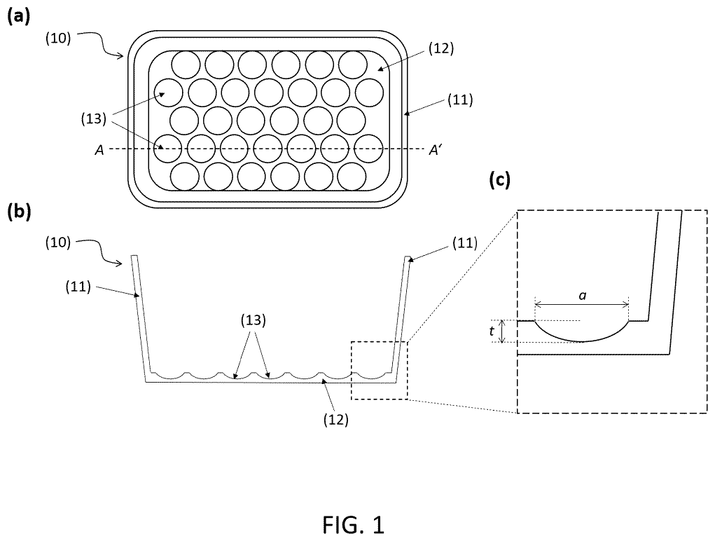

FIG. 1 shows a device according to the invention in plan view (from the “top”). The device (10) comprises walls (11) and a bottom (12), which together form a dish. The bottom (12) has the shape of a rectangle with rounded corners. Depressions (13) are made in the bottom (12). The depressions form the regular pattern of a honeycomb structure. FIG. 1 (b) shows the device in cross section along the dashed lines A-A′ from the side. The walls (11) extend at an angle of more than 90° from the bottom (12) in terms of height. FIG. 1 (c) shows a detail of FIG. 1 (b) in an enlarged illustration. The depressions (13) have the shape of a spherical segment. In the plane of the bottom (12) (in plan view), the depressions (13) have a round shape with the diameter/the extent a. The depressions (13) have a maximum depth t.

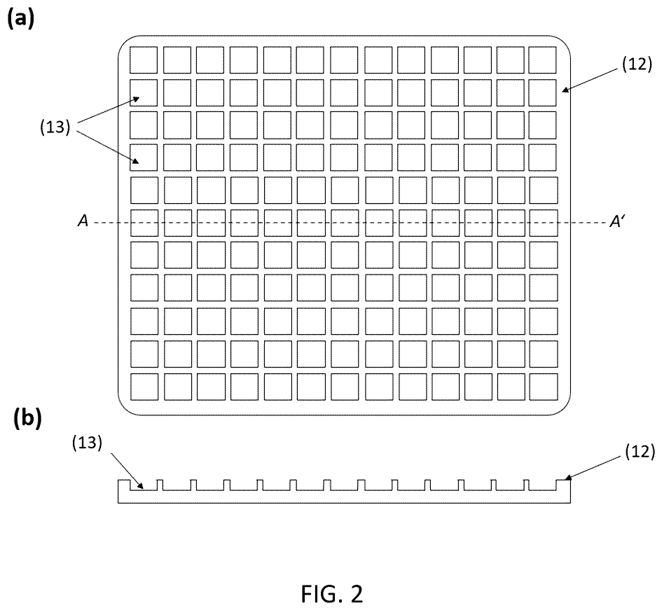

FIG. 2 (a) shows a further embodiment of the bottom of a device according to the invention in plan view (from the “top”). Depressions (13) are made in the bottom (12). The depressions (13) have the shape of squares. The depressions (13) form a regular square pattern. FIG. 2 (b) shows the bottom (12) in cross section along A-A′ from the side.

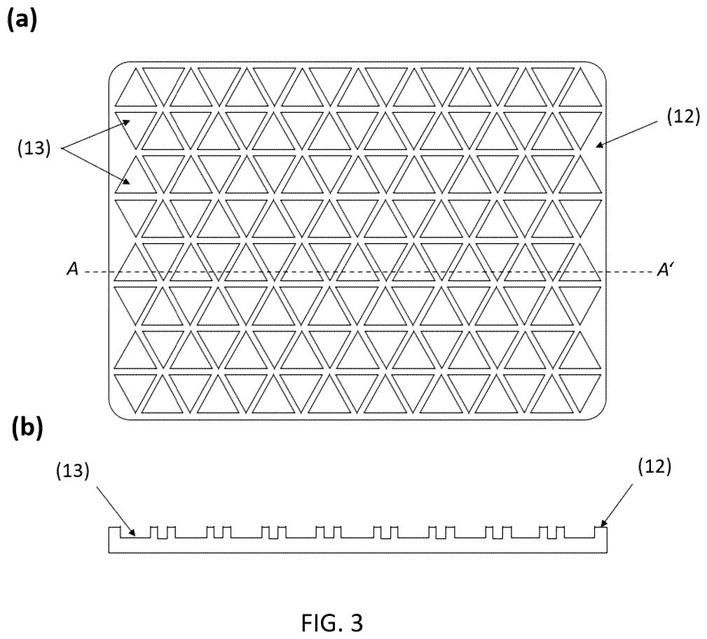

FIG. 3 (a) shows a further embodiment of the bottom of a device according to the invention in plan view (from the “top”). Depressions (13) are made in the bottom (12). The depressions (13) have the shape of cylinders with a triangular base shape. The depressions (13) form a regular hexagonal pattern. FIG. 3 (b) shows the bottom (12) in cross section along A-A′ from the side.

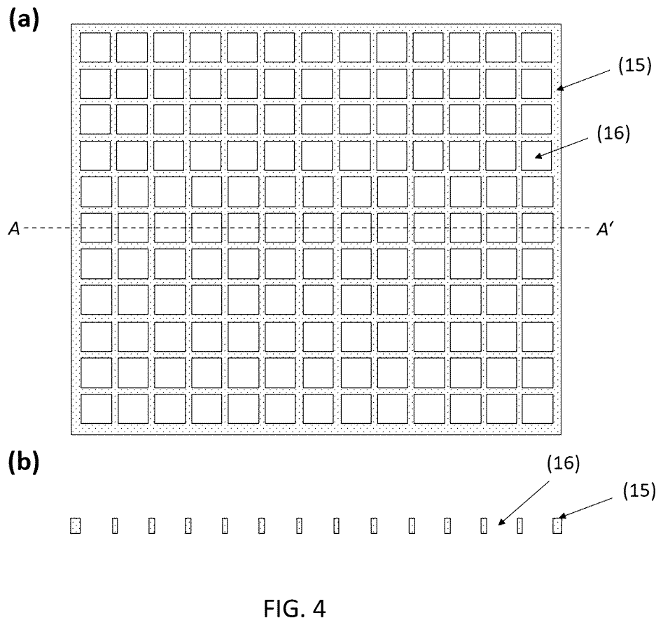

FIG. 4 (a) shows one embodiment of an insert for a device according to the invention in plan view (from the “top”). The insert consists of a flat, square body (15) in which cutouts (16) are made, resulting in a lattice. The cutouts (16) are square and form a regular square pattern. FIG. 4 (b) shows the body (15) with the cutouts (16) in cross section along A-A′from the side.

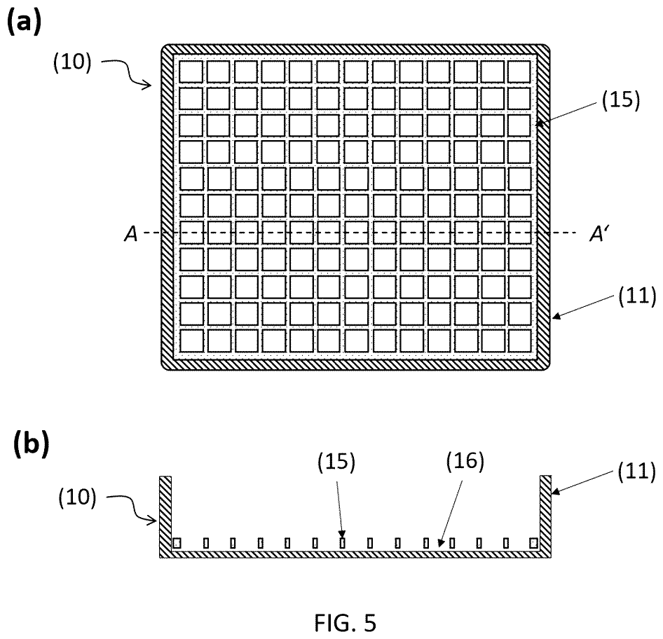

FIG. 5 (a) shows the insert of FIG. 4, which is introduced in a dish, in plan view (from the “top”). In the present example, the insert has been placed in the dish. FIG. 5 (b) shows the dish with insert in cross section along A-A′ from the side. By virtue of the insert, in the dish a bottom with depressions is produced. The bottom is formed by the body (15), the depressions by the cutouts (16).

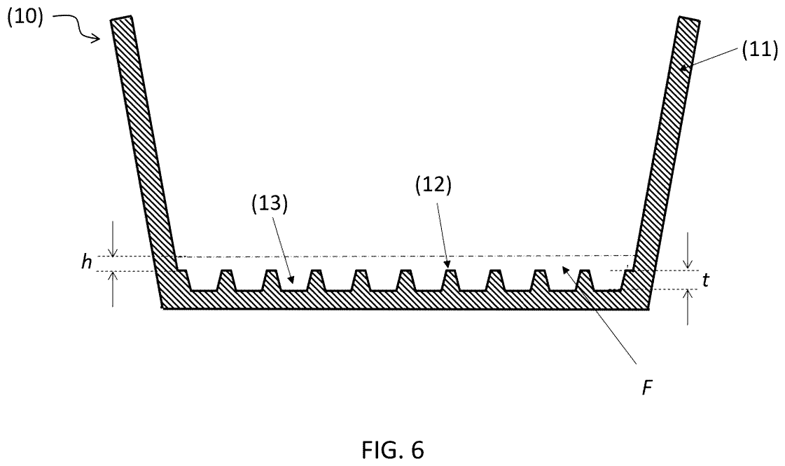

FIG. 6 (a) shows a device comprising walls (11) and a bottom (12) with depressions (13), which together form a dish. A liquid F has been introduced into the device. The liquid F forms a liquid surface (illustrated by a dash-dotted line). The shortest distance h between the surface of the liquid and part of the bottom (12) that does not have any depressions is smaller than the depth t of the depressions (13).

What is claimed is:

1. A device for immobilizing pests, comprising a dish for receiving a liquid, wherein the dish comprises a bottom and walls which provide a volume for receiving the liquid, and wherein the bottom has a plurality of depressions.

2. The device as claimed in claim 1, further comprising a camera and/or a mount for a camera.

3. The device as claimed in claim 1, further comprising a source of electromagnetic radiation.

4. The device as claimed in claim 1, further comprising means for positioning the device in a field for crop plants, at a height to which the crop plants grow or above the height to which the crop plants grow.

5. The device as claimed in claim 1, wherein the bottom comprises one or more first regions which comprise no depressions, and the bottom comprises one or more second regions which comprise the plurality of depressions, wherein the one or more first regions occupy a first surface area and the one or more second regions occupy a second surface area, wherein the first surface area is smaller than the second surface area.

6. The device as claimed in claim 1, wherein regions of the bottom that adjoin the walls are free of depressions, and wherein the depressions of the multiple depressions otherwise extend over the entire bottom.

7. The device as claimed in claim 1, wherein the depressions are arranged in a regular pattern.

8. The device as claimed in claim 1, wherein the depressions form a Platonic tiling.

9. The device as claimed in claim 1, wherein the depressions form the shape of a honeycomb structure.

10. The device as claimed in claim 1, wherein each depression of the multiple depressions has an extent of at least about 2 mm and at most about 8 mm in a plane of the bottom.

11. The device as claimed in claim 1, wherein each depression of the multiple depressions has a depth of about 1 mm to about 5 mm.

12. The device as claimed in claim 1, wherein the bottom with the depressions is formed by an insert which can be reversibly removed from the dish.

13. The device as claimed in claim 1, wherein the depressions have a shape of a spherical segment, a frustum of a cone, a frustum of a cylinder, a frustum of a pyramid, a cube or a cuboid.

14. The device as claimed in claim 1, further comprising means which set the liquid in motion at defined points in time.

15. The device as claimed in claim 1, further comprising a camera having an image sensor, wherein the image sensor has a rectangular shape with an aspect ratio, wherein the dish has a rectangular shape in plan view, wherein the rectangular shape of the dish has an aspect ratio corresponding to the aspect ratio of the image sensor of the camera.

16. A method comprising the following steps:
providing a device comprising a dish, wherein the dish comprises a bottom and walls which provide a volume for receiving a liquid, and wherein the bottom has a plurality of depressions;
filling the dish with the liquid;
waiting until one or more pests enter the dish and are completely or partially in the liquid;
identifying a pest of the one or more pests located in a depression of the plurality of depressions of the bottom of the dish, or identifying and/or counting a plurality of pests in the plurality of depressions of the bottom of the dish.

17. The method as claimed in claim 16, wherein the dish is filled with an amount of the liquid which has the effect that the shortest distance between a surface of the liquid and a part of the bottom that does not have any depressions is less than depth of the depressions.

18. A method of using a device, wherein the device comprises a dish for receiving a liquid, wherein the dish comprises a bottom and walls which provide a volume for receiving the liquid, and wherein the bottom has a plurality of depressions, the method comprising immobilizing by the device and/or identifying pests in the device, in an area where crop plants are cultivated.
